(19) United States
(12) Patent Application Publication
(10) Pub. No.: US 2009/0178884 A1
(43) Pub. Date: Jul. 16, 2009

(54) Combination Treestand and Game Carrier

(76) Inventors: Charles Joseph Maletestinic, Bressler, PA (US); Vincent Lawrence Radic, JR., Bressler, PA (US)

Correspondence Address: Charles Joseph Maletestinic, 575 Penn Street, Bressler, PA, 17113, US

(21) Appl. No.: 12/350,996

(22) Filed: Jan. 9, 2009

Related U.S. Application Data
(60) Provisional application No. 61/019,987, filed on Jan. 9, 2008.

(51) Int. Cl. E06C 7/00

(52) U.S. Cl. 182/20

(57) ABSTRACT

A combination treestand and game carrier enables ready conversion between the operating modes. A kit enables modification of pre-existing treestands to be configured into a game carrier.

### FIELD OF THE INVENTION

The present invention relates to sports equipment, and more particularly to hunting support equipment, and even more particularly to a combination treestand and game carrier, and corresponding methods and kits.

### BACKGROUND

Conventional treestands enable a hunter or game watcher to sit or stand on an elevated platform. Some treestands include detachable ladder sections that can be assembled in the field to form a contiguous ladder. The assembled ladder 210, as shown for example in FIG. 1, the can be supported on a tree by a strap 212 and a rigid brace 214. A platform 216 extends from the top of the ladder and includes a seat 218 and footrest 220. The seat extends approximately at a right angle from the ladder and is attached to strap 212.

On many treestands that have detachable ladder sections, the ladder sections are configured to be carried on the hunter's back. Often, treestands are not permanently attached to a tree, but rather are disassembled and removed at the end of each hunting season or even more frequently.

### SUMMARY OF THE INVENTION

A combination treestand and game carrier is capable of being assembled into a tree stand configuration and a game carrier cart configuration. The combination in the tree stand configuration comprises: a rigid ladder assembly formed of discrete, disenagageable ladder units; a footrest located proximate a top of the ladder; a seat located above the foot rest; posts for receiving wheels; and a contact surface capable of contacting a tree located proximate the seat. The combination in the game carrier configuration forming a platform or carting game comprises: the ladder units disengaged and arranged mutually parallel; wheels coupled to the posts for enabling rolling of the combination in the cart configuration; and a handle located opposite the wheels to enable pushing or pulling of the cart.

Preferably the seat, the footrest, and the contact surface are formed on a unitary top unit that mates to one of the ladder units such that the top unit forms at least a portion of a chassis for the game carrier configuration. The footrest may include a foot contact portion and a support such that an aperture is formed between the foot contact portion and the support, wherein the aperture receives at least one of the ladder units while the combination is in the cart configuration to retain an end thereof. In this case, the ladder units may be more narrow than the frame of the top unit. Alternatively, the ladder units and the frame of the top unit have approximately the same width such that the foot platform extends through the ladder units to retain the ladder units in the game carrier configuration. The handle may include a cord that at least partly retains the ladder units.

A method of using the combination includes assembling the ladder units and mounting to a tree and disassembling the combination, including disengaging the ladder units, and assembling the components into a game carrier, as described herein.

A kit for modifying a pre-existing treestand to enable the treestand to be configured into a game carrier, comprises: a brace; fasteners for attaching the brace to a pre-existing treestand; a post rigidly extending from the brace; wheels for mounting on the post and for rotation thereon, the wheels capable of supporting the treestand in a game carrier configuration; and fasteners for retaining the wheels on the posts. The kit may also include a handle for retaining disengaged ladder units and capable of grasping for pulling the game carrier.

### BRIEF DESCRIPTION OF THE FIGURES

FIG. 1 is an elevation view of a treestand illustrating an embodiment of the present invention;

FIG. 2 is an exploded view of the treestand embodiment shown in FIG. 1;

FIG. 3 is a top view of a game carrier formed from the components of the embodiment of FIG. 1;

FIG. 4 is a side view of a portion of the game carrier of FIG. 3;

FIG. 5 is an elevation view of a treestand illustrating a second embodiment of the present invention;

FIG. 6 is a photo of a portion of the second treestand embodiment;

FIG. 7 is a view of components of the second treestand embodiment;

FIG. 8 is a side photograph of the game carrier formed from the components of the second treestand embodiment;

FIG. 9 is another view of wheel assemblies for each of the first embodiment and second embodiment game carriers;

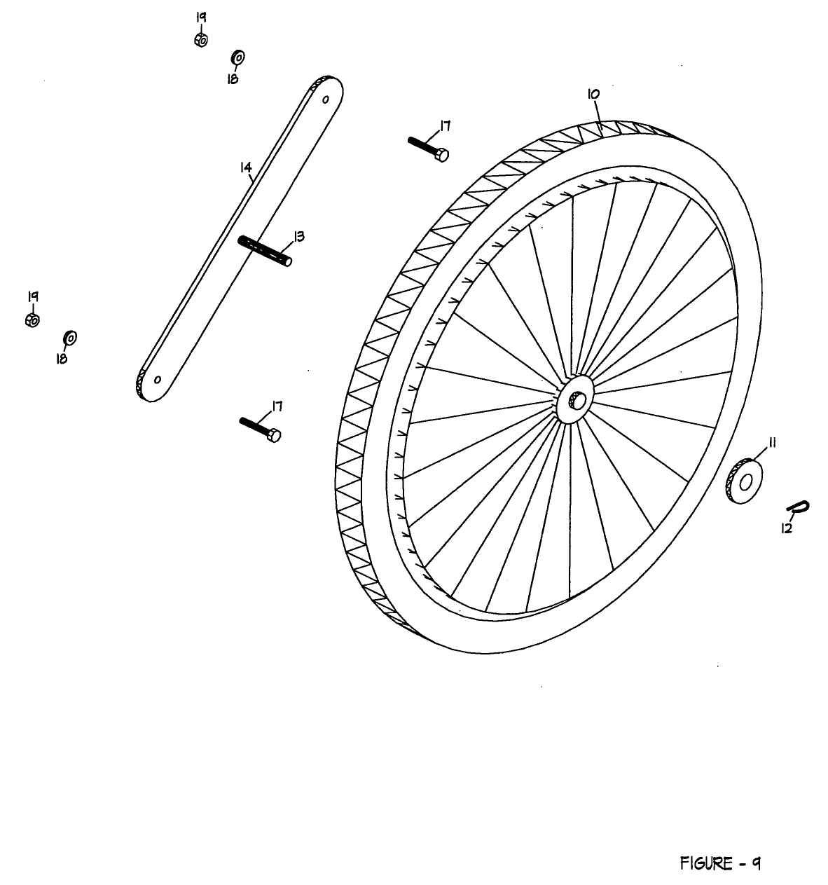

FIG. 10 is an exploded view of components for a wheel assembly kit for modifying a treestand according to another aspect of the present invention;

FIG. 11 is an exploded view of components for a wheel assembly kit for modifying a treestand having a different configuration from that of FIG. 10; and

FIG. 12 is a perspective photograph of a prior art treestand.

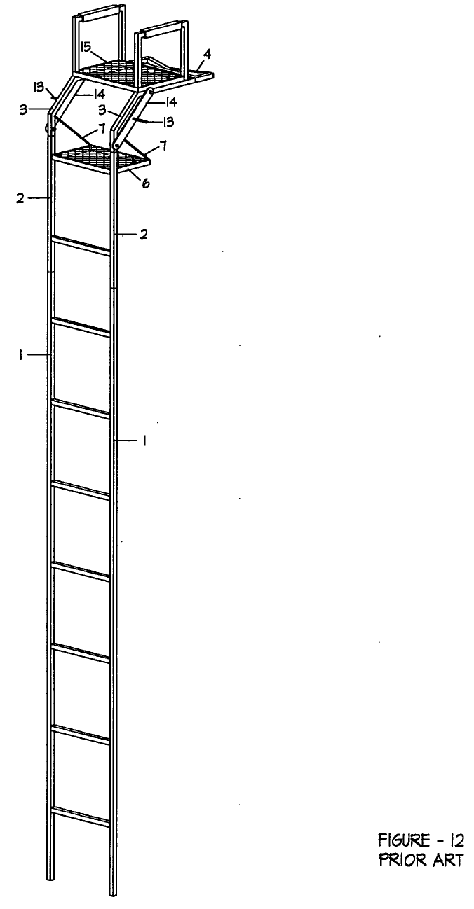

### DESCRIPTION OF PREFERRED EMBODIMENTS

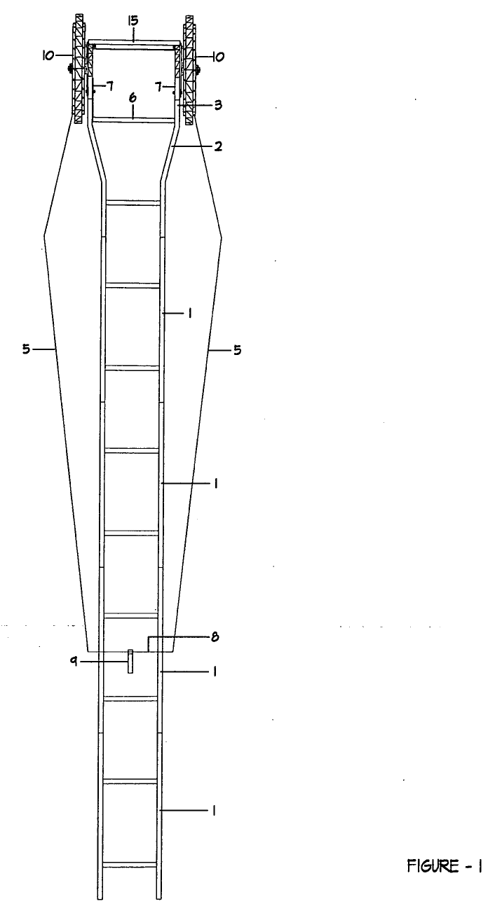

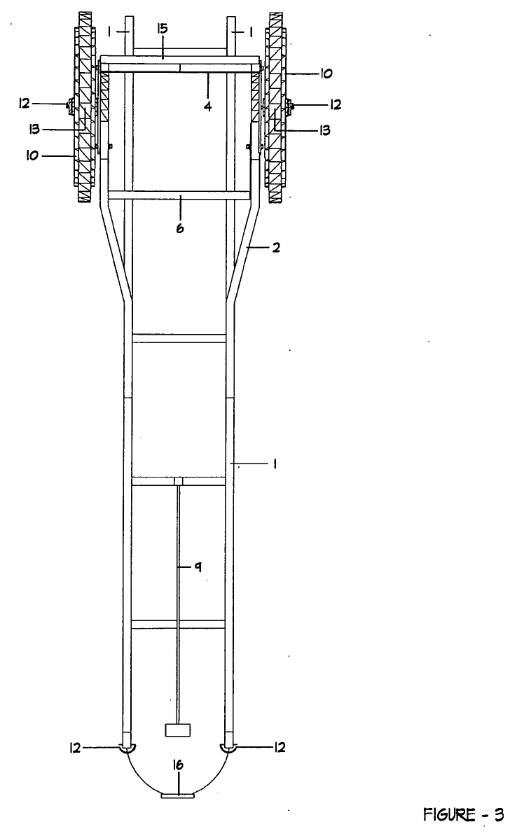

A first embodiment of a combination treestand and game carrier is configured to be readily assembled into its treestand configuration, indicated by reference numeral 30 and shown in FIG. 1, and then broken down and assembled into its cart or game carrier configuration, indicated by reference numeral 40 and shown in FIG. 3. The component parts may be configured to form both treestand 30 and the cart 40 by a hunter remotely in a forest, preferably without tools. The same reference numerals are used to identify the parts, where applicable, in the treestand mode 30 and game carrier mode 40.

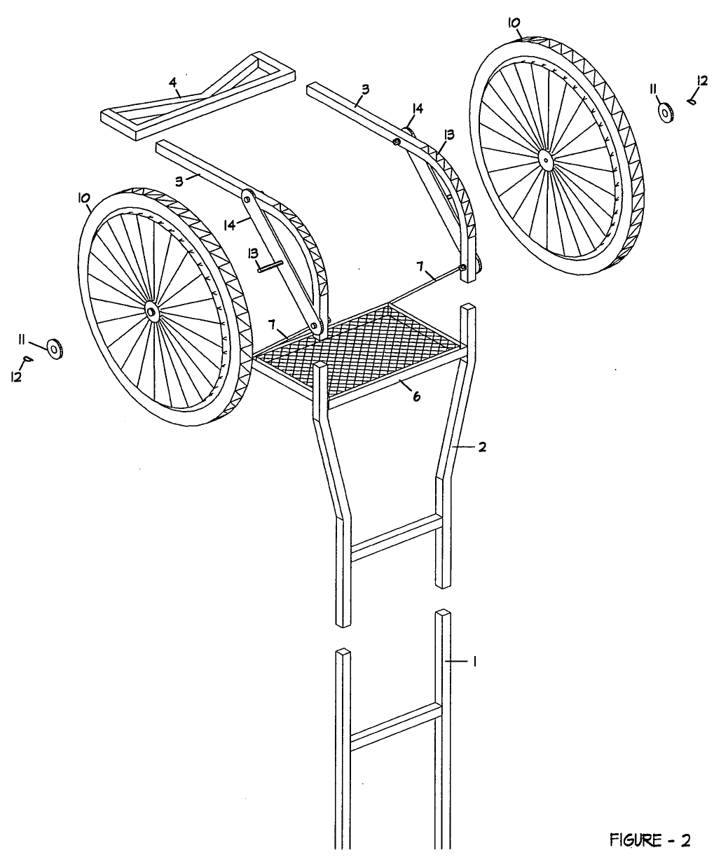

FIG. 1 shows a treestand 30 in its assembled state with the tree removed for clarity. FIG. 2 shows portions of treestand 30 in an exploded view for clarity. Treestand 30 includes individual ladder units 1 and a top unit 2. The lowermost ladder unit 1 may have feet for engaging the ground. Other (optionally) than at its bottommost end, each ladder unit 1 includes a means for attachment to an adjacent ladder unit. For example, where the ladder frames are formed of square tubing, one end of a mating part may be deformed to be insertable into its mating part. Alternatively, the present invention encompasses any means of attaching one ladder unit part to another to form a continuous ladder. Further, the present invention encompasses ladder units 1 that are fully separable, hinged together, attached via shock cords, or any other configuration and still be encompassed within the definition of removable or disengageable, as those terms are used herein.

Top unit 2 includes a pair of opposing frame members 3, a footrest or foot platform 6, and a seat 15. Frame members 3 are on opposing sides of foot platform 6 and seat 16. Each frame member 3 includes an approximately vertical frame member 3a and an approximately horizontal frame member 3b, as oriented in the treestand mode. Vertical frame member 3a extends upwardly from the uppermost portion of the top ladder unit 1. Foot platform 6 extends transversely between vertical frame members 3a. Preferably, an inboard side of foot platform 6 is attached at each side to frame members 3a. A pair of platform supports 7 are oblique to vertical frame members 3a and extend from the frame members 3a to an inboard side (that is, nearest the tree) of foot platform 6 for structural support of platform 6.

Frame members 3a and 3b preferably form an approximately right angle such that horizontal frame members 3b extend to the tree (not shown in the Figures for clarity). A bar 4 having teeth or barbs extends approximately horizontally between the distal ends of frame members 3b for engaging the tree. Seat 15 extends between frame horizontal members 3b. In the embodiment of treestand 30, ladder units 1 are narrower than frame 3, which has the known advantage of increasing portability and diminishing weight.

The assembly may be secured to the tree by any means, including conventional stabilizing ropes or straps 5 that extend from an attachment point on the ladder unit 1 around the tree to the distal ends of frame members 3, a lower strap 8 that extends around the tree, and a rigid brace 9 that extends between one of the ladder units 1 and the tree.

Treestand 30 also includes posts 13 for attaching wheels 10. Preferably, posts 13 extend outwardly from each side of top unit 2 and the wheels are removed while the components are assembled in treestand mode 30. Preferably, a brace 14 extends obliquely between frame members 3a and 3b on each side of treestand to provide a mount for posts 13.

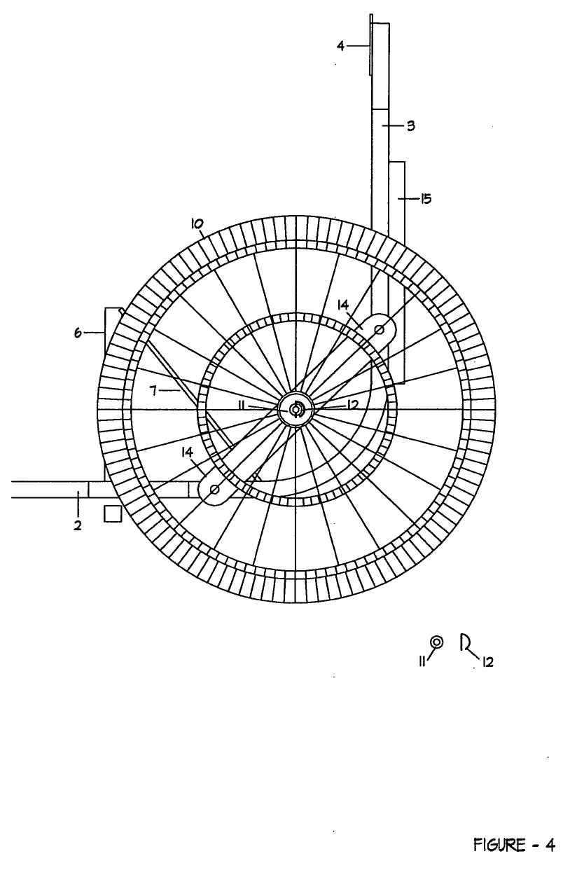

Referring to FIGS. 3 and 4 to illustrate the components configured in the cart mode, game carrier 40 has the ladder units 1 disengaged from one another and placed one on top of another. Preferably, top unit 2 is turned approximately 90 degrees from its treestand configuration 30 with frame member 3b, which had been horizontal, pointing upward. One of ladder units 1a is still coupled to top unit 2 to form a chassis for cart 40. Alternatively, the top ladder unit 1A may be permanently affixed to top unit 2 (not shown in the Figures). Other ones of the ladder units 1 are located on top of the chassis.

Foot platform 6 includes a transverse support 20 that extends between frame supports 3a and forms an aperture 21 with foot platform 6. The ladder units 1 are inserted into and located in aperture 21 for retaining ladder units at one end. At the opposite end (that is, the handle end) ladder units may be held together by any means, including quick connect D-rings 12 as shown in FIG. 3. A handle 16 preferably is a cord that extends between ends the ends of the chassis frame and includes a handgrip. The cord may also hold the front ends of ladder units 1 together.

Wheels 10, which for a conventional treestand height preferably are 20 inch or 24 inch spoke wheels, are installed onto posts 13 and held into place by an O-ring 11 and hinged, D-clip 12. The present invention encompasses other means for attaching the wheels or other components. For example, spring loaded O-rings or lynch pins may be used in place of wherever D-clips are mentioned herein.

As is clear from the figures, treestand 30 may be easily broken down by disengaging ladder units 1 and affixing wheels 10 onto posts 13 by hardware 11 and 12. As described above, a ladder unit 1a and top unit 2 form a chassis, and loose ladder units 1 may be laid on top of the chassis and inserted through aperture 21 in platform 6 at one end. Handle 16 may then be grasped by a user to lift the unit and pull it as a cart even if loaded with heavy game. The top portion of the chassis provides a platform on which game may be placed and wheeled. Upstanding frame 3 or teeth 4 and footrest 6 may also form a portion of the platform for carrying game.

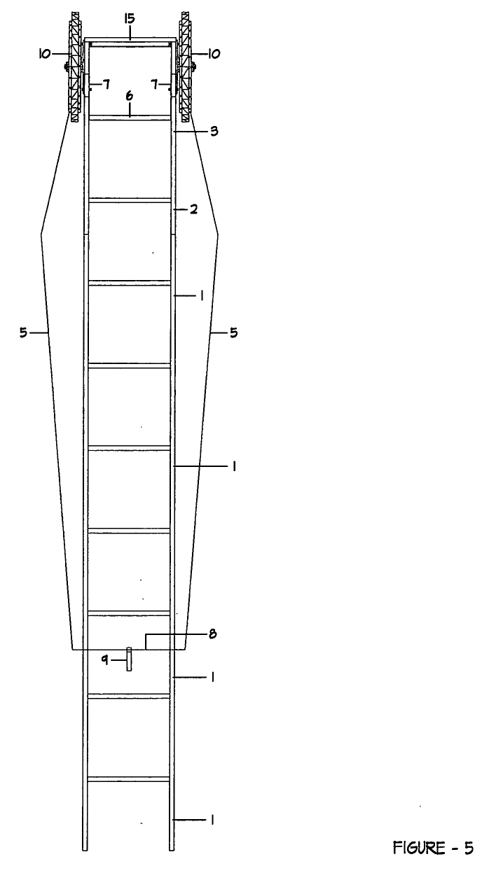

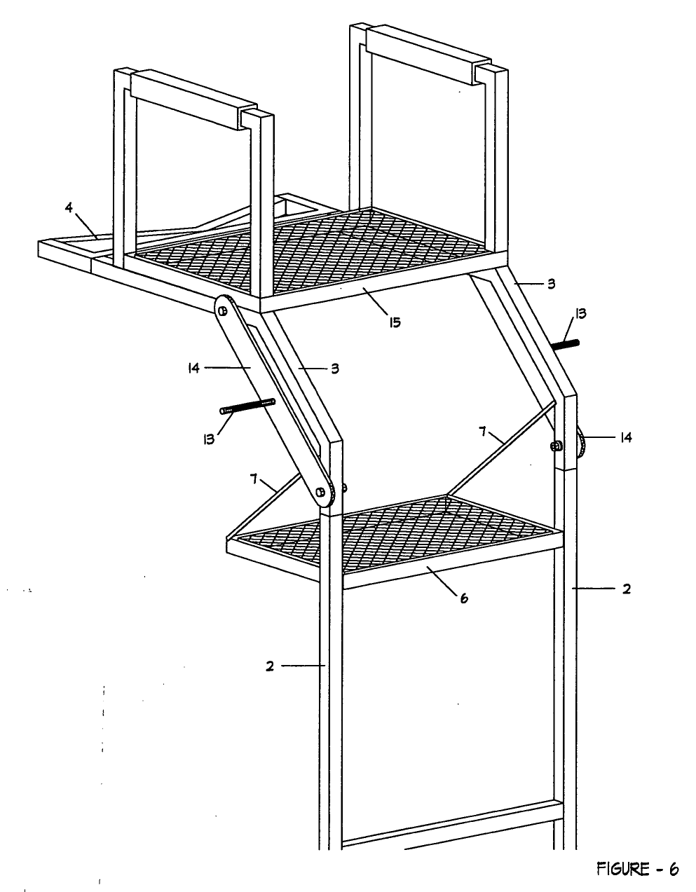

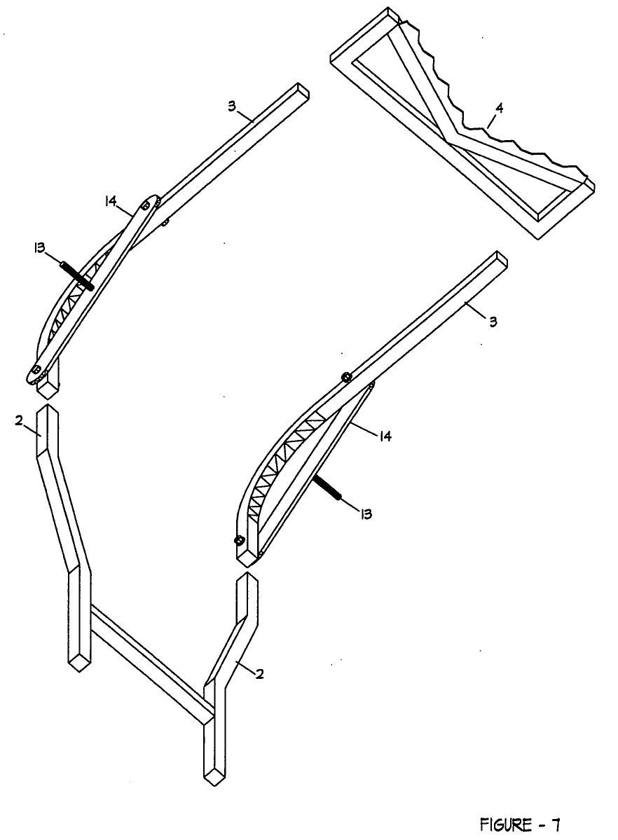

FIGS. 5, 6, and 7 illustrate a second embodiment treestand 50 that includes individual ladder units 1′ and a top unit 2′. The lowermost ladder unit 1′ may have feet for engaging the ground.

Top unit 2′ includes a pair of opposing frame members 3′, a footrest or foot platform 6′, and a seat 15′. Frame members 3′ are on opposing sides of foot platform 6′ and seat 16′. Each frame member 3′ includes an approximately vertical frame member 3a′ and an approximately horizontal frame member 3b′, as oriented in the treestand mode. Vertical frame member 3a′ extends upwardly from the uppermost portion of the top ladder unit 1′. Foot platform 6′ is oriented and supported as described above for first embodiment platform 6. Foot platform 6′ is continuous and does not require an aperture, as explained below. Barbed bar 4′ and seat 15′ are as described above for first embodiment platform 6. The assembly includes a strap 5′, and lower strap 8′, and a rigid brace 9′ as described above for first treestand embodiment 30.

Frame members 3a′ and 3b′ preferably form an approximately right angle such that horizontal frame members 3b′ extend to the tree (not shown in the Figures for clarity). In the embodiment of treestand 50, ladder units 1′ and frame members 3′ have approximately the same width.

Treestand 50 also includes posts 13′ for attaching wheels 10′. Preferably, posts 13′ extend outwardly from each side of top unit 2′ and the wheels are removed while the components are assembled in treestand mode 50. Preferably, a brace 14′ extends obliquely between frame members 3a′ and 3b′ on each side of treestand to provide a mount for posts 13′.

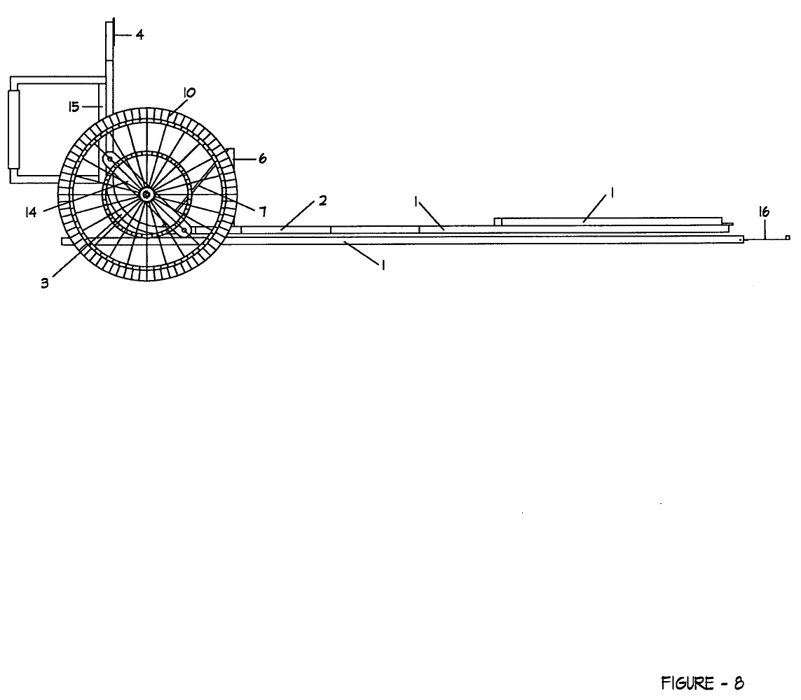

Referring to FIG. 8 to illustrate the components configured in the cart mode, game carrier 60 has the ladder units 1′ disengaged from one another and placed one on top of another. Preferably, top unit 2′ is turned approximately 90 degrees from its treestand configuration 50 with frame member 3b′, which had been horizontal, pointing upward. One of ladder units 1a′ is still coupled to top unit 2 to form a chassis for cart 60. Alternatively, top unit may have a ladder unit permanently affixed (not shown in the Figures). Other ones of the ladder units 1′ are located on top of the chassis.

Foot platform 6′ is upright in the orientation shown in FIG. 8 and narrower than the space between the frames of ladder units 1′. Ladder units 1′ preferably are placed over platform 6′. At the opposite end (that is, the handle end), ladder units 1′, D-rings 12′, and handle 16′ are as described above for treestand embodiment 30. Wheels 10′, O-ring 11′, and hinged, D-clip 12′ are as described for treestand embodiment 30.

Treestand 50 may be easily broken down by disengaging ladder units 1′ and affixing wheels 10′ onto posts 13′ by hardware 11′ and 12′. Ladder unit 1a′ and top unit 2 form a chassis, and loose ladder units 1′ may be laid on top of the chassis and over foot platform 6′ for retention of the ends of ladder units 1′. Handle 16′ may then be grasped by a user to lift the unit and pull it as a cart even if loaded with heavy game.

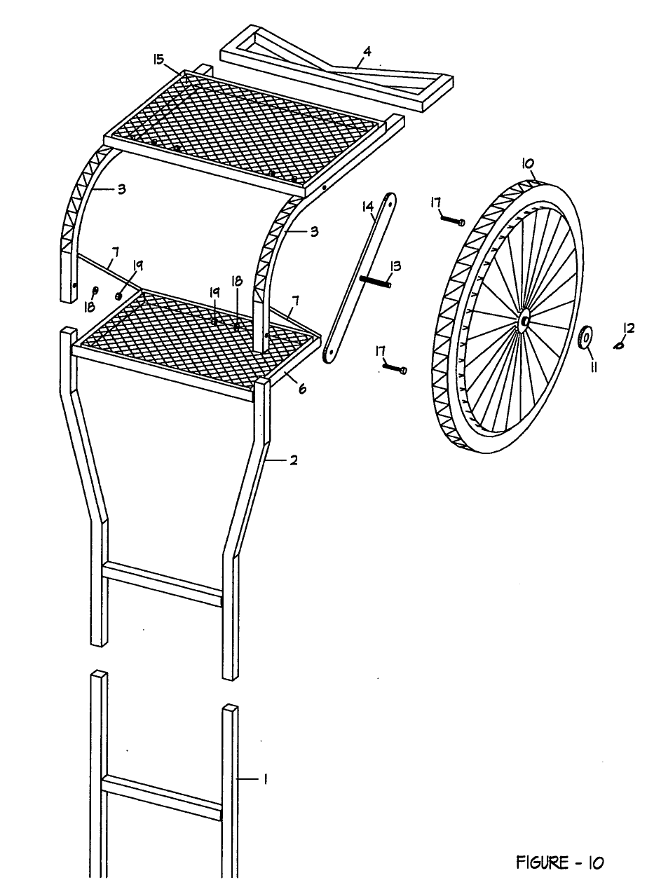

FIG. 10 illustrates components of a wheel kit assembly 70 that may be used to modify a treestand. Reference numerals for first treestand embodiment 30 and game carrier 40 will be used to describe kit 70, and it is understood that kit 70 is not limited to any particular treestand configuration.

Kit 70 includes a brace 114 includes a structural brace 114, a post 113 that protrudes from brace 114, a wheel assembly 110, hardware for attaching the wheel 110 to post 113, and hardware for attaching brace 114 to a treestand. The hardware for attaching wheel 110 to post 113 includes an O-ring 110 and a D-clip 114, which are generally as described above for first and second embodiment game carriers 40 and 60. The hardware for attaching brace 114 to a pre-existing treestand includes a pair of bolts 117 with corresponding washers and nuts. Because it is preferably to provide a pair of wheels for the game carrier configuration, kit 70 preferably includes two of each of the components listed above.

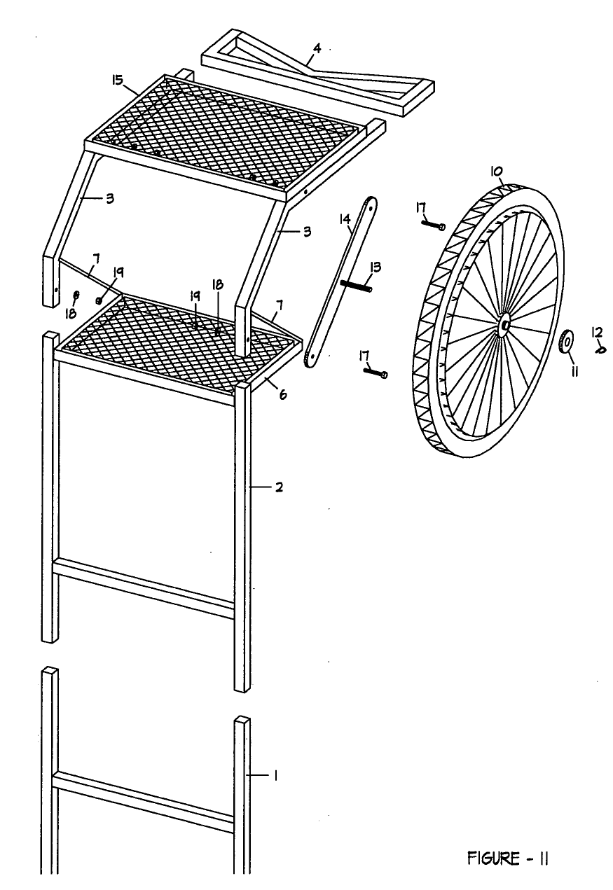

When a treestand, especially a pre-existing treestand, is intended to be modified by kit 70, locations on the treestand for holes to receive bolts 117 are determined. For the treestand shown in FIG. 10, locations on the horizontal and vertical frame members are determined. For the treestand shown in FIG. 11, which has an angled section between its horizontal and vertical frame members suitable for accepting brace 114, location of holes may be simplified.

Bolts 117 are inserted into the holes in the treestand and through corresponding holes in brace 114 to attached brace 117 in its desired location. Wheel 110 may be attached to post 113 as described above for game carriers 40 and 60.

Aspects of the present invention are illustrated by description of the above embodiments. The present invention is not limited to the particular structure or function described herein, but rather broadly encompasses any structure and function stated in the claims or following logically from the description.

We claim:

1. A combination tree stand and game carrier capable of being assembled into a tree stand configuration and a game carrier cart configuration,
the combination in the tree stand configuration comprising:
a rigid ladder assembly formed of discrete, disenagageable ladder units;
a footrest located proximate a top of the ladder;
a seat located above the foot rest;
posts for receiving wheels;
a contact surface capable of contacting a tree located proximate the seat; and
the combination in the game carrier configuration forming a platform or carting game, comprising:
the ladder units disengaged and arranged mutually parallel;
wheels coupled to the posts for enabling rolling of the combination in the cart configuration; and
a handle located opposite the wheels to enable pushing or pulling of the cart.

2. The combination of claim 1 wherein the seat, the footrest, and the contact surface are formed on a unitary top unit that mates to one of the ladder units.

3. The combination of claim 2 wherein the top unit forms at least a portion of a chassis for the game carrier configuration.

4. The combination of claim 3 wherein the footrest includes a foot contact portion and a support such that an aperture is formed between the foot contact portion and the support, wherein the aperture receives at least one of the ladder units while the combination is in the cart configuration to retain an end thereof.

5. The combination of claim 4 wherein the top unit includes a pair of opposing peripheral top supports, wherein the footrest is affixed between the top supports, wherein the seat is affixed between the top supports.

6. The combination of claim 5 wherein the top supports are wider than the ladder units.

7. The combination of claim 3 wherein the ladder units and a frame of the top unit have approximately the same width and wherein the foot platform extends through the ladder units to retain the ladder units in the game carrier configuration.

8. The combination of claim 1 wherein the wheels are retained on the posts by quick connections.

9. The combination of claim 1 wherein the handle includes a cord that at least partly retains the ladder units.

10. A method of using the combination of claim 1 including assembling the ladder units and mounting to a tree and disassembling the combination, including disengaging the ladder units, and assembling the components into a game carrier, as described above.

11. A kit for modifying a pre-existing treestand to enable the treestand to be configured into a game carrier, comprising:
a brace;
fasteners for attaching the brace to a pre-existing treestand;
a post rigidly extending from the brace;
wheels for mounting on the post and for rotation thereon, the wheels capable of supporting the treestand in a game carrier configuration; and
and fasteners for retaining the wheels on the posts.

12. The kit of claim 11 further comprising a handle for retaining disengaged ladder units and capable of grasping for pulling the game carrier.

13. The kit of claim 11 wherein the fasteners for retaining the wheels on the posts are quick connections.

14. The kit of claim 11 wherein the quick connections are hinged D-rings.
